(19) United States
(12) Patent Application Publication
(10) Pub. No.: US 2024/0235049 A9
(43) Pub. Date: Jul. 11, 2024

(54) Methods of Manufacturing Electromagnetic Radiation Altering Articles, Articles Made by the Methods, Apparatuses, and Methods of Altering Electromagnetic Radiation

(71) Applicant: 3M INNOVATIVE PROPERTIES COMPANY, St. Paul, MN (US)

(72) Inventors: Jens Eichler, Kaarst (DE); Christian Weinmann, Alsdorf (DE); Tom Gaide, Köln (DE); Michael H. Stalder, Uedem (DE); Sebastian Eggert-Richter, Wülfrath (DE)

(21) Appl. No.: 18/278,391

(22) PCT Filed: Jan. 24, 2022
(86) PCT No.: PCT/IB2022/050599

§ 371 Date: Aug. 22, 2023

Related U.S. Application Data
(60) Provisional application No. 63/152,980, filed on Feb. 24, 2021.

(51) Int. Cl. H01Q 15/02; B29C 64/393; B33Y 10/00; B33Y 50/02; B33Y 80/00; H01Q 15/00

(52) U.S. Cl. CPC H01Q 15/02; B29C 64/393; B33Y 10/00; B33Y 50/02; B33Y 80/00; H01Q 15/0013; H01Q 15/0086; B29C 64/124

(57) ABSTRACT

The present disclosure provides methods, articles, and apparatuses related to altering electromagnetic radiation. A method of making articles includes a) forming an electromagnetic radiation altering material by providing a polymer matrix and optionally embedding dielectric particles in the polymer matrix and b) obtaining initial dielectric properties of the electromagnetic radiation altering material. The method further includes c) modeling electromagnetic radiation altering features of the material suitable for the article obtained from the material to have target electromagnetic radiation altering properties, thereby obtaining a simulation of the electromagnetic radiation altering article; and d) additive manufacturing the electromagnetic radiation altering article based on the simulation of the electromagnetic radiation altering article. An electromagnetic radiation altering article obtained by the method is also provided. Further, an apparatus is provided including the electromagnetic radiation altering article. Methods of altering electromagnetic radiation are provided, including integrating an electromagnetic radiation altering article into either an electronic device or an electromagnetic radiation producing device, or placing the article in the vicinity of the device. Aspects of the present disclosure advantageously contribute to achieving optimized materials and designs for electromagnetic radiation altering articles.

### SUMMARY

Methods, articles, and apparatuses are provided related to altering electromagnetic radiation. In a first aspect, a method of manufacturing an electromagnetic radiation altering article is provided. The method includes the steps of: a) forming an electromagnetic radiation altering material by providing a polymer matrix and optionally embedding a plurality of dielectric particles in the polymer matrix; and b) obtaining initial dielectric properties of the electromagnetic radiation altering material, including the initial relative dielectric permittivity (εr 1) and the initial dielectric loss tangent (tan delta 1), when measured at a frequency F1. The method further includes c) modeling electromagnetic radiation altering features of the electromagnetic radiation altering material suitable for the electromagnetic radiation altering article obtained from the electromagnetic radiation altering material to have target electromagnetic radiation altering properties, thereby obtaining a simulation of the electromagnetic radiation altering article; and d) additive manufacturing the electromagnetic radiation altering article based on the simulation of the electromagnetic radiation altering article. Optionally, the method further includes e) measuring the electromagnetic radiation altering properties of the electromagnetic radiation altering article obtained from additive manufacturing, and comparing the measured electromagnetic radiation altering properties of the electromagnetic radiation altering article with the target electromagnetic radiation altering properties.

In a second aspect, an electromagnetic radiation altering article is provided. The electromagnetic radiation altering article is obtained by a method according to the first aspect.

In a third aspect, an apparatus is provided. The apparatus includes an electromagnetic radiation altering article according to the second aspect.

In a fourth aspect, a method of altering electromagnetic radiation originating from an electromagnetic radiation producing device and received by an electronic device is provided. The method includes the step of integrating an article according to the second aspect into the electronic device or placing an article according to the second aspect in the vicinity of the electronic device.

In a fifth aspect, a method of altering electromagnetic radiation originating from an electromagnetic radiation producing device is provided. The method comprises the step of integrating an article according to the second aspect into the electromagnetic radiation producing device or placing an article according to the second aspect in the vicinity of the electromagnetic radiation producing device.

At least certain aspects of the present disclosure advantageously contribute to achieving optimized materials and designs for electromagnetic radiation altering articles.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a flow chart of an exemplary method of manufacturing an electromagnetic radiation altering article according to the present disclosure.

FIG. 2 is a schematic perspective view of an additive manufacturing apparatus.

FIG. 3 is a block diagram of a generalized system for additive manufacturing of an article.

FIG. 4 is a block diagram of a generalized manufacturing process for an article.

FIG. 5 is a high-level flow chart of an exemplary article manufacturing process.

FIG. 6 is a high-level flow chart of an exemplary article additive manufacturing process.

FIG. 7 is a schematic front view of an exemplary computing device.

FIG. 8 is a schematic perspective end view of a plate having an internal honeycomb structure, according to Example 4.

FIG. 9A is a graph of dielectric permittivity for a solid plate and a honeycomb plate, according to Example 4.

FIG. 9B is a graph of dielectric loss factor for a solid plate and a honeycomb plate, according to Example 4.

FIG. 10A is a schematic perspective view of a frequency selective surface (FSS) prototype.

FIG. 10B is a schematic side view of a portion of the FSS prototype of FIG. 10A.

FIG. 10C is a photograph of the sample according to Example 5.

FIG. 11 is a schematic cross-sectional side view of a chamber for testing an FSS.

FIG. 12 is a graph showing simulated and measured FSS transmission of the sample according to Example 5.

While the above-identified figures set forth several embodiments of the disclosure, other embodiments are also contemplated, as noted in the description. The figures are not necessarily drawn to scale. In all cases, this disclosure presents the invention by way of representation and not limitation.

### DETAILED DESCRIPTION

### Glossary

As used herein, “actinic radiation” encompasses UV radiation, e-beam radiation, visible radiation, infrared radiation, gamma radiation, and any combination thereof.

As used herein, “matrix” refers to a three-dimensionally continuous medium.

As used herein, a “monomer” is a single, one unit molecule capable of combination with itself or other monomers to form oligomers or polymers; an “oligomer” is a component having 2 to 9 repeat units; and a “polymer” is a component having 10 or more repeat units.

As used herein, “particle” refers to a substance being a solid having a shape which can be geometrically determined. The shape can be regular or irregular. Particles can typically be analyzed with respect to, e.g., particle size and particle size distribution. A particle can comprise one or more crystallites. Thus, a particle can comprise one or more crystal phases. The term “primary particle size” refers to the size of a non-associated single nanoparticle, which is considered to be a primary particle. X-ray diffraction (XRD) is typically used to measure the primary particle size of crystalline materials; transmission electron microscopy (TEM) is typically used to measure the primary particle size of amorphous materials.

As used herein, “diameter” refers to the longest straight length across a shape (two-dimensional or three-dimensional) that intersects a center of the shape.

As used herein, “fluid” refers to emulsions, dispersions, suspensions, solutions, and pure components having a continuous liquid phase, and excludes powders and particulates in solid form.

As used herein, “curing” and “polymerizing” each mean the hardening or partial hardening of a composition by any mechanism, e.g., by heat, light, radiation, e-beam, microwave, chemical reaction, or combinations thereof.

As used herein, “cured” refers to a material or composition that has been hardened or partially hardened (e.g., polymerized or crosslinked) by one or more curing mechanisms.

As used herein, each of “photopolymerizable” and “photocurable” refers to a composition containing at least one material that can be hardened or partially hardened using actinic radiation.

As used herein, the term “(meth)acrylate” is a shorthand reference to acrylate, methacrylate, or combinations thereof, “(meth)acrylic” is a shorthand reference to acrylic, methacrylic, or combinations thereof, and “(meth)acryl” is a shorthand reference to acryl and methacryl groups. “Acryl” refers to derivatives of acrylic acid, such as acrylates, methacrylates, acrylamides, and methacrylamides. By “(meth)acryl” is meant a monomer or oligomer having at least one acryl or methacryl group and linked by an aliphatic segment if containing two or more groups. As used herein, “(meth)acrylate-functional compounds” are compounds that include, among other things, a (meth)acrylate moiety.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

Altering electromagnetic waves is of commercial importance in various ways. Often, an electronic device (e.g., a “victim”) is protected from interfering electromagnetic waves from another device or apparatus (e.g., an “interferer”) by any of reflection, attenuation, or redirection. With the ever-increasing density of electronic devices as well as digitalization of more and more technical fields, solutions for protection of devices gains increasing importance. One application area is the adaptation of distribution of electromagnetic waves from an antenna signal, such as altering a direction of the electromagnetic waves due to local limitations or increasing the efficiency of the antenna.

The present disclosure provides a combination of dielectric materials (e.g., dielectric polymers and/or dielectric particle filled polymers) having specific electromagnetic radiation wave altering designs with the use of additive manufacturing (e.g., also referred to as “3D-printing”) design freedom. The dielectric materials can be classified in four general material classes (i.e., transparent, redirecting, absorbing, or reflecting electromagnetic waves). Additive manufacturing offers unique possibilities to offer solutions with respect to weight reduction or easier assembly due to new design options. In some cases, depending on a frequency range, certain dielectric filler particles are suitable, and can be processed in polymer matrix composite-based additive manufacturing or 3D-printing technologies (e.g., selective laser sintering (SLS), stereolithography (SLA), etc.). Further, part design and material adaption optimization concepts are provided herein, which allow the rapid and customizable adaption of electromagnetic wave altering designs based on the application requirements. The combination of material and design adaption can leverage the design freedom provided by additive manufacturing, therefore offering specific solutions to further improve electromagnetic wave altering capabilities for various applications.

Electromagnetic wave altering designs have various forms, e.g., including different principles of lens designs, frequency selective surfaces, meta materials, and absorbers.

Electromagnetic lenses or electromagnetic redirectors can be used to generate an interference pattern to effectively bundle or redirect the electromagnetic energy to a focal point or a different direction. The necessary different phase delays can be realized through different runtimes (e.g., group delays) of the electromagnetic wave through the lens medium. This may be achieved by modifying either thickness or effective permittivity as a gradient along the material. The gradient may be continuous or stepped, depending on the required specifications. Additive manufacturing, for instance, can be used to generate nearly any kind of surface topology on the material to generate this gradient. The topology can also (or alternatively) be hidden inside the material block or realized by different densities of the material. In case of multi-material additive manufacturing, material gradients or composition changes can be used.

Frequency-selective-surfaces or -materials act like a filter for pre-defined wavelengths. Some frequencies can pass through while others will get reflected. This can be achieved by adding structural features (e.g., holes, slots, inclusions, etc.) on or inside the material that have a magnitude of a wavelength. By generating these kinds of resonant features, particularly using additive manufacturing, a substantial freedom to generate complex frequency characteristics can be achieved. This may lead to solutions that can be tailored to specific needs. For instance, a cover for an antenna could be created, which is transparent in the frequency bandwidth of the used communication channel but reflects at other frequencies to shield the antenna from unwanted signals.

Absorbers transfer electromagnetic energy into heat. This phenomenon can be used, for example, to protect electronic circuits from radiation. A high lossy material may be printed via additive manufacturing to have a shape designed to perfectly fit onto the printed circuit board (pcb) of the protected or interfering circuit. This design freedom enables the absorber to be used also inside tight housings to support miniaturization.

Alternatively, the structure of an electromagnetic radiation altering material can be designed in a way that it creates an effective medium. The properties of the unstructured material can be altered using hollow, porous, or grid-like structures in cases where the radiation wavelength is much larger (e.g., more than 4 times larger) than the structural feature size. As an example, a direct comparison of dielectric properties can be determined for an unfilled base polymer once as a solid plate and once reducing total weight using a honeycomb design, for instance as described in the examples below. The effective medium principle may be used to generate a material with an even lower permittivity (e.g., closer to 1), leading to enhanced transparent materials. This design option also offers weight reduction potential.

Another variant of the effective medium principle includes metamaterials. “Metamaterials” is a collective term for materials with electromagnetic properties normally not found in nature. Usually, the real part of permeability and/or permittivity of a material is positive. With metamaterials, both properties are negative leading to a negative refractive index (i.e., double negative materials (DNG)). By designing small inclusions that are small compared to the wavelength of the surrounding medium but resonant for the bulk material, the real part of both permittivity and permeability can be designed to be negative for a certain small frequency band. Such a material can lead to useful designs for, e.g., antennas, lenses, miniaturization, etc.

### Method of Manufacturing an Electromagnetic Radiation Altering Article

In a first aspect, a method is provided. The method of manufacturing an electromagnetic radiation altering article comprises the steps of:
a) forming an electromagnetic radiation altering material by providing a polymer matrix and optionally embedding a plurality of dielectric particles in the polymer matrix;
b) obtaining initial dielectric properties of the electromagnetic radiation altering material, comprising the initial relative dielectric permittivity (εr 1) and the initial dielectric loss tangent (tan delta 1) when measured at a frequency F1;
c) modeling electromagnetic radiation altering features of the electromagnetic radiation altering material suitable for the electromagnetic radiation altering article obtained from the electromagnetic radiation altering material to have target electromagnetic radiation altering properties, thereby obtaining a simulation of the electromagnetic radiation altering article;
d) additive manufacturing the electromagnetic radiation altering article based on the simulation of the electromagnetic radiation altering article; and
e) optionally, measuring the electromagnetic radiation altering properties of the electromagnetic radiation altering article obtained from additive manufacturing, and comparing the measured electromagnetic radiation altering properties of the electromagnetic radiation altering article with the target electromagnetic radiation altering properties.

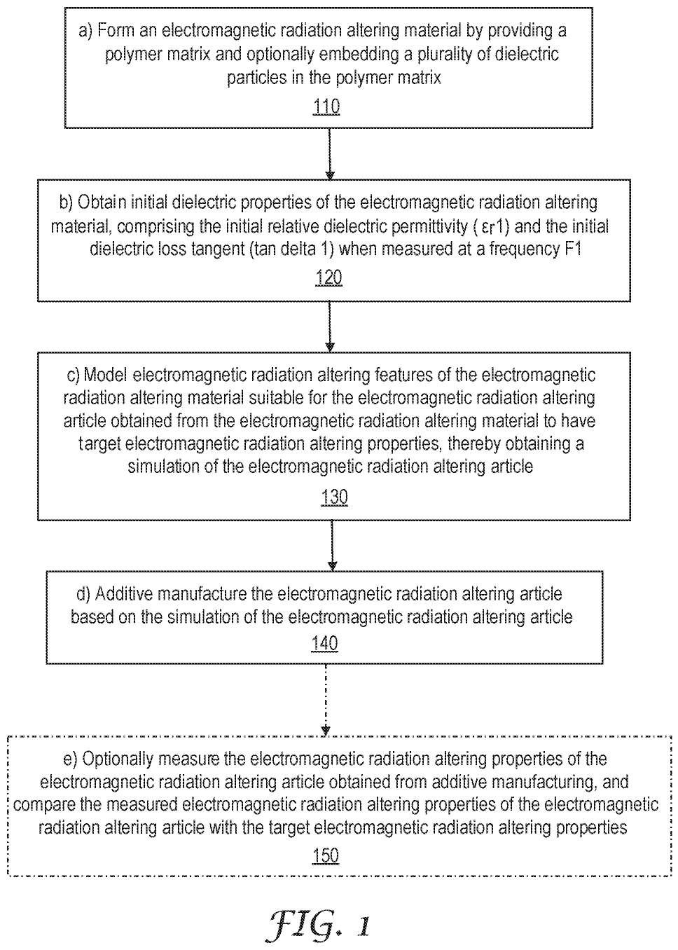

Referring to FIG. 1, a flow chart is provided of the method of the first aspect. More particularly, the method comprises Step 110 to a) form an electromagnetic radiation altering material by providing a polymer matrix and optionally embedding a plurality of dielectric particles in the polymer matrix. Often, the step of forming an electromagnetic radiation altering material comprises the steps of selecting an initial polymer matrix and selecting a plurality of initial dielectric particles for embedding therein. Exemplary polymeric materials for use in the polymer matrix and dielectric particles are described in detail below. In the case that an unfilled polymer matrix is employed, the polymeric material comprises a dielectric material.

The method further comprises Step 120 to b) obtain initial dielectric properties of the electromagnetic radiation altering material, comprising the initial relative dielectric permittivity (Cr 1) and the initial dielectric loss tangent (tan delta 1) when measured at a frequency F1. In some embodiments, the step of obtaining initial dielectric properties of the electromagnetic radiation altering material is performed by measuring the initial dielectric properties using a measurement method selected from the group consisting of a transmission and/or a reflection method, a dielectric resonance method (i.e., a split post dielectric resonator (SPDR) method), a capacitance method, an LC resonance (also referred to as “U/I”) method, a perturbation method, an open resonator method, and any combinations thereof. Preferred measurement methods of initial dielectric properties may be selected from the group consisting of a reflection method, an LC resonance (U/I) method, a dielectric resonance (SPDR) method, and any combinations thereof. Each of these methods is discussed further below. In some embodiments, the initial dielectric properties are already available and can be accessed, e.g., from a database or data sheet.

A suitable transmission and/or reflection method can be either realized using conductive or radiative methods. Conductive transmission and/or reflective methods include coaxial or waveguide transmission line methods. Radiative transmission and/or reflective methods include free-field measurement setups in an anechoic RF measurement chamber and quasi-optical methods using reflectors and lenses or a combination hereof.

A suitable dielectric resonance method (e.g., split post dielectric resonator) is described in detail in the examples below, as the “Dielectric Resonance (SPDR) Measurement Method”.

A suitable capacitance method includes measurement of a well-known test capacitor-structure with an exchangeable dielectric medium between the plates and measuring the change in capacitance conducted by the different dielectric materials.

A suitable LC resonance method (or U/I method) includes use of an LCR meter to determine the resonance properties of a combined RLC Circuit, exchanging the dielectric material of the associated Capacitor with the material under test and calculating the dielectric properties from the resulting differences of the resonance properties.

A suitable perturbation method includes measurement of the resonance properties of a cavity resonator, monitoring the change of resonance properties when inserting a dielectric sample and calculating dielectric properties from the perturbation of resonance properties.

A suitable open resonator method includes usage e.g. of a Fabry-Perot open resonator.

In some embodiments, the frequency F1 at which the initial dielectric properties of the electromagnetic radiation altering material are measured is in a range from 300 MHz to 300 GHz.

In some embodiments, the frequency F1 is in a range from 300 MHz to 3 GHz (e.g., Ultra High Frequency (UHF)). In some embodiments, the frequency F1 is in a range from 3 GHz to 30 GHz (e.g., Super High Frequency (SHF)). In some embodiments, the frequency F1 is in a range from GHz to 300 GHz (e.g., Extremely High Frequency (EHF)). In some embodiments, the frequency F1 is in a range from 1 to 10 GHz, from 1 to 8 GHz, from 1 to 6 GHz, or even from 2 to 6 GHz (e.g., a 5G mid GHz range).

In some embodiments, the electromagnetic radiation altering material has an initial relative dielectric permittivity (εr 1) in the range from 1 to 3.0, from 1 to 2.8, from 1.0 to 2.5, from 1.2 to 2.3, or even from 1.5 to 2.0, when measured at 5.2 GHz according to the Dielectric Resonance (SPDR) Measurement Method, which is described in the examples below. In some embodiments, the electromagnetic radiation altering material has an initial relative dielectric permittivity (εr 1) in the range from 4 to 11, from 4.5 to 11, from 5 to 10, from 5 to 9, or even from 5 to 8, when measured at 5.2 GHz according to the Dielectric Resonance (SPDR) Measurement Method. In some embodiments, the electromagnetic radiation altering material has an initial relative dielectric permittivity (εr 1) greater than 15, when measured at 5.2 GHz according to the Dielectric Resonance (SPDR) Measurement Method. In some embodiments, the electromagnetic radiation altering material has an initial relative dielectric permittivity (εr 1) of 100 or less, 70 or less, 50 or less, 40 or less, or 30 or less, when measured at 5.2 GHz according to the Dielectric Resonance (SPDR) Measurement Method.

In some embodiments, the electromagnetic radiation altering material has an initial dielectric loss tangent (tan delta 1) in the range from 0.01 to 0.04, from 0.01 to 0.03 or even from 0.01 to 0.02, when measured at 5.2 GHz according to the Dielectric Resonance (SPDR) Measurement Method, which is described in the examples below. In some embodiments, the electromagnetic radiation altering material has an initial dielectric loss tangent (tan delta 1) in the range from 0.05 to 0.15, from 0.06 to 0.12 or even from 0.08 to 0.12, when measured at 5.2 GHz according to the Dielectric Resonance (SPDR) Measurement Method. In some embodiments, the electromagnetic radiation altering material has an initial dielectric loss tangent (tan delta 1) in the range from 0.2 to 0.5, from 0.2 to 0.45 or even from 0.2 to 0.4, when measured at 5.2 GHz according to the Dielectric Resonance (SPDR) Measurement Method. In some embodiments, the electromagnetic radiation altering material has an initial dielectric loss tangent (tan delta 1) greater than 0.5, when measured at 5.2 GHz according to the Dielectric Resonance (SPDR) Measurement Method. In some embodiments, the electromagnetic radiation altering material has an initial dielectric loss tangent (tan delta 1) of 0.8 or less or 0.6 or less, when measured at 5.2 GHz according to the Dielectric Resonance (SPDR) Measurement Method.

In some preferred embodiments, the electromagnetic radiation altering material has an initial relative dielectric permittivity (C r 1) in the range from 12 to 15 and an initial dielectric loss tangent (tan delta 1) in the range from 0.01 to 0.15, when measured at 5.2 GHz according to the Dielectric Resonance (SPDR) Measurement Method. In some preferred embodiments, the electromagnetic radiation altering material has an initial relative dielectric permittivity (εr 1) in the range from 12 to 15 and an initial dielectric loss tangent (tan delta 1) in the range from 0.2 to 0.5, when measured at 5.2 GHz according to the Dielectric Resonance (SPDR) Measurement Method.

Referring again to FIG. 1, the method of manufacturing an electromagnetic radiation altering article further comprises Step 130 to c) model electromagnetic radiation altering features of the electromagnetic radiation altering material suitable for the electromagnetic radiation altering article obtained from the electromagnetic radiation altering material to have target electromagnetic radiation altering properties, thereby obtaining a simulation of the electromagnetic radiation altering article.

In some embodiments, the step of modeling electromagnetic radiation altering features of the electromagnetic radiation altering material is performed using the initial dielectric properties of the electromagnetic radiation altering material obtained by a method selected from the group consisting of a transmission/reflection method, a free field measurement, a transmission line method, a dielectric resonance (SPDR) method, a capacitance method, an LC resonance (U/I) method, a perturbation method, an open resonator method, and any combinations thereof. Preferred measurement methods may be selected from the group consisting of a reflection/transmission method, an LC resonance (U/I) method, a dielectric resonance (SPDR) method, and any combinations thereof.

Exemplary suitable electromagnetic radiation altering features of the electromagnetic radiation altering material may be selected from the group consisting of electromagnetic lenses, diffractive gratings, frequency selective surfaces or materials, electromagnetic energy absorbers, metamaterials, and any combinations thereof. In select embodiments, the electromagnetic radiation altering features are electromagnetic lenses, redirectors and/or electromagnetic energy absorbers.

In some embodiments, the step of modeling electromagnetic radiation altering features of the electromagnetic radiation altering material comprises the step of optimizing the electromagnetic radiation altering features of the electromagnetic radiation altering material for it to have target electromagnetic radiation altering properties. In some embodiments, the step of modeling electromagnetic radiation altering features of the electromagnetic radiation altering material comprises the step of simulating the electromagnetic radiation altering properties of the simulation of the electromagnetic radiation altering article by conducting electromagnetic radiation altering calculations on the simulation of the electromagnetic radiation altering article. Suitable modeling techniques include, for instance and without limitation, analytical calculations, finite element simulation, finite-difference time-domain method simulation, and method of moments simulation.

In some embodiments, the target electromagnetic radiation altering properties comprise dielectric properties of the electromagnetic radiation altering article comprising a target relative dielectric permittivity (εr 2) and a target dielectric loss tangent (tan delta 2) when measured at a frequency F2. In some embodiments, the target electromagnetic radiation altering properties comprise magnetic properties of the electromagnetic radiation altering material comprising a target relative magnetic permeability (μr 2) when measured at a frequency F2. In some embodiments, the target electromagnetic radiation altering properties comprise magnetic properties of the electromagnetic radiation altering material comprising a target magnetic loss tangent (tan delta 4) when measured at a frequency F2.

In certain embodiments, the frequency F2 at which the dielectric properties of the electromagnetic radiation altering material are measured is in a range from 300 MHz to 300 GHz. In certain embodiments, the frequency F2 is in a range from 300 MHz to 3 GHz (e.g., Ultra High Frequency (UHF)). In certain embodiments, the frequency F2 is in a range from 3 GHz to 30 GHz (e.g., Super High Frequency (SHF)). In certain embodiments, the frequency F2 is in a range from GHz to 300 GHz (e.g., Extremely High Frequency (EHF)). In certain embodiments, the frequency F2 is in a range from 1 to 10 GHz, from 1 to 8 GHz, from 1 to 6 GHz, or even from 2 to 6 GHz (e.g., a 5G mid GHz range).

Referring again to FIG. 1, the method of manufacturing an electromagnetic radiation altering article further comprises Step 140 to d) additive manufacture the electromagnetic radiation altering article based on the simulation of the electromagnetic radiation altering article. In some embodiments, the step of additive manufacturing the electromagnetic radiation altering article based on the simulation of the electromagnetic radiation altering article is performed using an additive manufacturing method selected from the group consisting of stereolithography (SLA), selective laser sintering (SLS), digital light processing (DLP), selective laser melting (SLM), fused deposition modeling (FDM), direct light processing, binder jetting, material jetting, and any combinations thereof. In some preferred embodiments, the step of additive manufacturing the electromagnetic radiation altering article based on the simulation of the electromagnetic radiation altering article is performed using an additive manufacturing method selected from the group consisting of stereolithography (SLA), selective laser sintering (SLS), digital light processing (DLP), material jetting, and any combinations thereof. In certain embodiments, the additive manufacturing method employed comprises stereolithography (SLA). In certain embodiments, the additive manufacturing method comprises selective laser sintering (SLS). In certain embodiments, the additive manufacturing method comprises digital light processing (DLP). In certain embodiments, the additive manufacturing method comprises material jetting.

Methods of printing a three-dimensional object described herein can include forming the article from a plurality of layers of a photopolymerizable composition described herein in a layer-by-layer manner. Further, the layers of a build material composition can be deposited according to an image of the three-dimensional object in a computer readable format. In some or all embodiments, the photopolymerizable composition is deposited according to preselected computer aided design (CAD) parameters (e.g., a data file).

It is to be understood that methods of manufacturing a three-dimensional object described herein can include so-called “stereolithography/vat polymerization” 3D printing methods. Other techniques for three-dimensional manufacturing are known and may be suitably adapted to use in the applications described herein. More generally, three-dimensional fabrication techniques continue to become available. All such techniques may be adapted to use with photopolymerizable compositions described herein, provided they offer compatible fabrication viscosities and resolutions for the specified article properties. Fabrication may be performed using any of the fabrication technologies described herein, either alone or in various combinations, using data representing a three-dimensional object, which may be reformatted or otherwise adapted as necessary for a particular printing or other fabrication technology.

It is entirely possible to form a three-dimensional object from a photopolymerizable composition using vat polymerization (e.g., stereolithography). For example, in some cases, a method of printing a three-dimensional object comprises retaining a photopolymerizable composition described herein in a fluid state in a container and selectively applying energy to the photopolymerizable composition in the container to solidify at least a portion of a fluid layer of the photopolymerizable composition, thereby forming a hardened layer that defines a cross-section of the three-dimensional object. Additionally, a method described herein can further comprise raising or lowering the hardened layer of photopolymerizable composition to provide a new or second fluid layer of unhardened photopolymerizable composition at the surface of the fluid in the container, followed by again selectively applying energy to the photopolymerizable composition in the container to solidify at least a portion of the new or second fluid layer of the photopolymerizable composition to form a second solidified layer that defines a second cross-section of the three-dimensional object. Further, the first and second cross-sections of the three-dimensional object can be bonded or adhered to one another in the z-direction (or build direction corresponding to the direction of raising or lowering recited above) by the application of the energy for solidifying the photopolymerizable composition. Moreover, selectively applying energy to the photopolymerizable composition in the container can comprise applying actinic radiation, such as UV radiation, visible radiation, or e-beam radiation, having a sufficient energy to cure the photopolymerizable composition. A method can also comprise planarizing a new layer of fluid photopolymerizable composition provided by raising or lowering an elevator platform. Such planarization can be carried out, in some cases, by utilizing a wiper or roller or a recoater. Planarization corrects the thickness of one or more layers prior to curing the material by evening the dispensed material to remove excess material and create a uniformly smooth exposed or flat up-facing surface on the support platform of the printer.

It is further to be understood that the foregoing process can be repeated a selected number of times to provide the three-dimensional object. For example, in some cases, this process can be repeated “n” number of times. Further, it is to be understood that one or more steps of a method described herein, such as a step of selectively applying energy to a layer of photopolymerizable composition, can be carried out according to an image of the three-dimensional object in a computer-readable format. Suitable stereolithography printers include the Viper Pro SLA, available from 3D Systems, Rock Hill, SC and the Asiga PICO PLUS 39, available from Asiga USA, Anaheim Hills, CA.

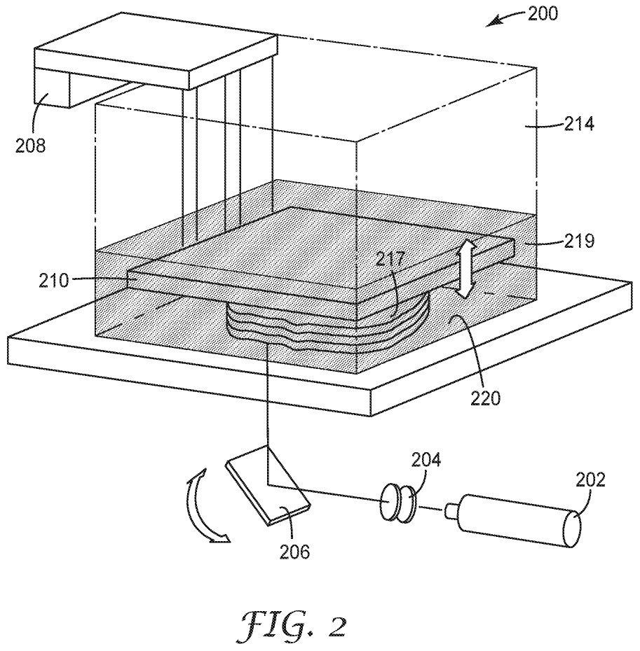

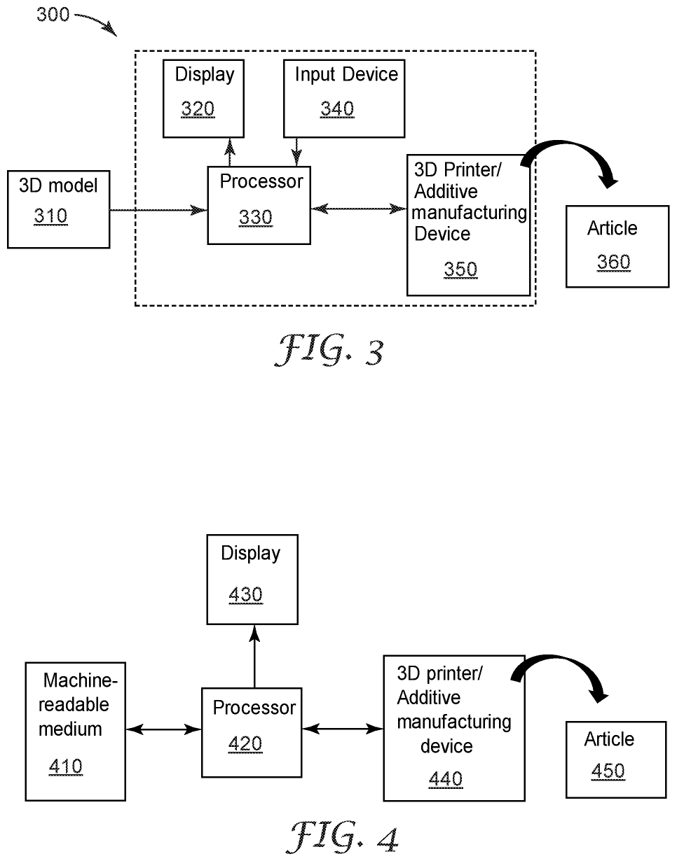

FIG. 2 shows a stereolithography apparatus (“SLA”) that may be used, for instance with the photopolymerizable compositions and methods described herein. In general, the apparatus 200 may include a laser 202, optics 204, a steering mirror or lens 206, an elevator 208, and a platform 210, within a vat 214 filled with the photopolymerizable composition 219. In operation, the laser 202 is steered through a wall 220 (e.g., the floor) of the vat 214 and into the photocurable composition to cure a cross-section of the photocurable composition 219 to form an article 217, after which the elevator 208 slightly raises the platform 210 and another cross section is cured. Suitable stereolithography printers include the NextDent 5100 and the FIG. 4, both available from 3D Systems, Rock Hill, SC, and the Asiga PICO PLUS 39, available from Asiga USA, Anaheim Hills, CA.

In some embodiments, vat polymerization with Digital Light Processing (“DLP”), employs a container of curable polymer (e.g., photopolymerizable composition). In a DLP based system, a two-dimensional cross section is projected onto the curable material to cure the desired section of an entire plane transverse to the projected beam at one time. One suitable apparatus for use with photopolymerizable compositions is the Rapid Shape D40 II DLP 3D printer (Rapid Shape GmbH, Heimsheim, Germany). All such curable polymer systems as may be adapted to use with the photopolymerizable compositions described herein are intended to fall within the scope of “vat polymerization” or “stereolithography” systems as used herein. In certain embodiments, an apparatus adapted to be used in a continuous mode may be employed, such as an apparatus commercially available from Carbon 3D, Inc. (Redwood City, CA), for instance as described in U.S. Pat. Nos. 9,205,601 and 9,360,757 (both to DeSimone et al.).

Data representing a three-dimensional article (e.g., an electromagnetic radiation altering article) may be generated using computer modeling, such as computer aided design (CAD) data. Image data representing the article design can be exported in STL format, or in any other suitable computer processable format, to the additive manufacturing equipment.

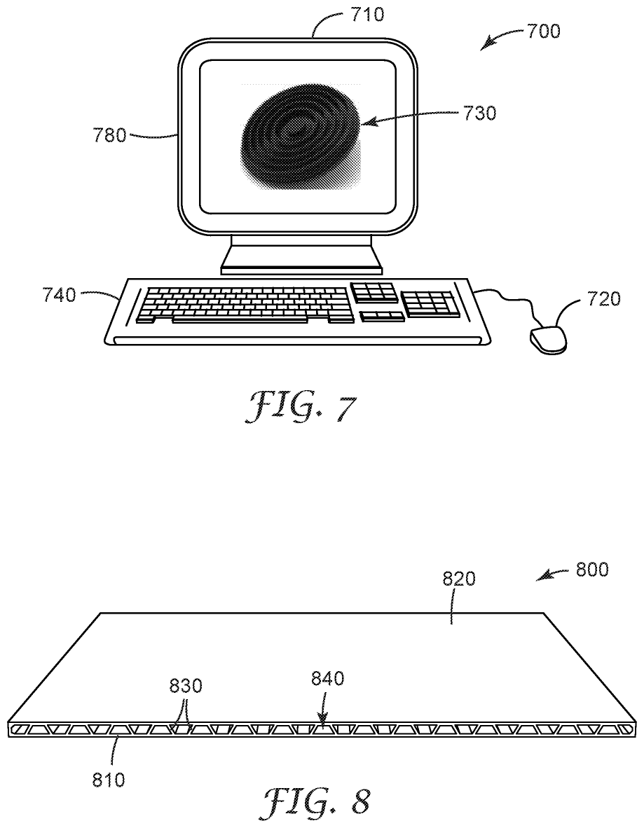

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to a computer, such as another networked computer. Referring to FIG. 7, a computing device 700 often includes an internal processor 780, a display 710 (e.g., a monitor), and one or more input devices such as a keyboard 740 and a mouse 720. In FIG. 7, an article 730 (e.g., a lens) is shown on the display 710.

Referring to FIG. 3, in certain embodiments, a system 300 is employed in the method of manufacturing an electromagnetic radiation altering article. The system 300 comprises a display 320 that displays a 3D model 310 of an article (e.g., an article 730 as shown on the display 710 of FIG. 7); and one or more processors 330 that, in response to the 3D model 310 selected by a user, cause a 3D printer/additive manufacturing device 350 to create a physical object of the article 360. Often, an input device 340 (e.g., keyboard and/or mouse) is employed with the display 320 and the at least one processor 330, particularly for the user to select the 3D model 310.

Referring to FIG. 4, a processor 420 (or more than one processor) is in communication with each of a machine-readable medium 410 (e.g., a non-transitory medium), a 3D printer/additive manufacturing device 440, and optionally a display 430 for viewing by a user. The 3D printer/additive manufacturing device 440 is configured to make one or more articles 450 based on instructions from the processor 420 providing data representing a 3D model of the article 450 (e.g., an article 730 as shown on the display 710 of FIG. 7) from the machine-readable medium 410.

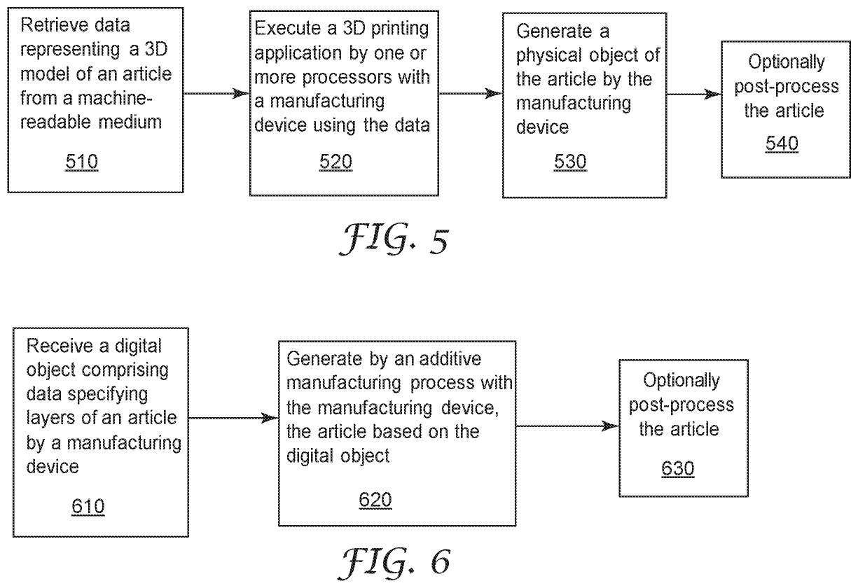

Referring to FIG. 5, for example and without limitation, an additive manufacturing method comprises retrieving 510, from a (e.g., non-transitory) machine-readable medium, data representing a 3D model of an article according to at least one embodiment of the present disclosure. The method further includes executing 520, by one or more processors, an additive manufacturing application interfacing with a manufacturing device using the data; and generating 530, by the manufacturing device, a physical object of the article. One or more various optional post-processing steps 540 may be undertaken. Typically, uncured photocurable component is removed from the article, plus the article may further be heat treated or otherwise post-cured. For instance, in some embodiments, the method further comprises, prior to Step c): retrieving, from a non-transitory machine readable medium, data representing a 3D model of the three-dimensional article; and executing, by one or more processors, a 3D printing application interfacing with a manufacturing device using the data to generate a physical object of the three-dimensional article.

Additionally, referring to FIG. 6, a method of making an article comprises receiving 610, by a manufacturing device having one or more processors, a digital object comprising data specifying an (e.g., three-dimensional) article; and generating 620, with the manufacturing device by an additive manufacturing process, the article based on the digital object. Again, the article may undergo one or more steps of post-processing 630. For instance, in some embodiments, the method further comprises, prior to Step c): receiving, by a manufacturing device having one or more processors, a digital object comprising data specifying the three-dimensional article; and generating, with the manufacturing device by an additive manufacturing process, the three-dimensional article based on the digital object.

Referring back to FIG. 1, in some embodiments, the method of manufacturing an electromagnetic radiation altering article further comprises Step 150 to e) optionally measure the electromagnetic radiation altering properties of the electromagnetic radiation altering article obtained from additive manufacturing, and to compare the measured electromagnetic radiation altering properties of the electromagnetic radiation altering article with the target electromagnetic radiation altering properties. In some embodiments, the electromagnetic radiation altering properties are measured using a method selected from the group consisting of radiative measurements, conductive measurements, and any combinations thereof.

In some embodiments, the method further comprises the step of obtaining (e.g., measuring, when the information is not otherwise available) initial magnetic properties of the electromagnetic radiation altering material, including the initial relative magnetic permeability (μr 1) when measured at a frequency F1. In some embodiments, the method further comprises the step of obtaining (e.g., measuring) initial magnetic properties of the electromagnetic radiation altering material, comprising the initial magnetic loss tangent (tan delta 3) when measured at a frequency F1. Often, the step of obtaining (e.g., measuring) initial magnetic properties of the electromagnetic radiation altering material is performed using a measurement method selected from the group consisting of a transmission line method, a free space transmission/reflection method, an LC resonance (U/I) method, and any combinations thereof.

In some embodiments, the electromagnetic radiation altering material has an initial relative magnetic permeability (μr 1) in the range from 1 to 1.5, from 1 to 1.3 or even from 1 to 1.2, when measured at 1.0 GHz according to the LC Resonance (U/I) Measurement Method, which is described in the examples below.

In some embodiments, the method further comprises the (e.g., iterative) step of replacing the initial polymer matrix and/or the plurality of initial dielectric particles by a different polymer matrix and/or a different plurality of dielectric particles (when dielectric particles are employed), and reiterating the process after the step of modeling electromagnetic radiation altering features of the electromagnetic radiation altering material. In some embodiments, the method further comprises the (e.g., iterative) step of re-modeling electromagnetic radiation altering features of the electromagnetic radiation altering material and reiterating the process after the step of measuring the electromagnetic radiation altering properties of the electromagnetic radiation altering article obtained from additive manufacturing. Such iterative processes may contribute to efficiently developing an electromagnetic radiation altering article that is tuned for a particular application, due to the short optimization cycles, especially in the design phase.

The aspects of material property as well as frequency dependency must be considered when choosing a material for simulation design optimization. Also, the processability must be considered. Therefore, the dielectric property need of the material depends on the combination of application electromagnetic radiation wave frequency, need for the design concept, scale to print (e.g., changing dielectric constant that leads to scaling of design) and scale to apply (e.g., changing dielectric constant to fit the needs of a particular application).

In practice, based on the boundary conditions (e.g., size) to fit an additive manufacturing process, the specific application, and the wavelength(s) to be altered, a series of materials (e.g., polymer matrices and optionally dielectric particles) is selected and developed to be produced using 3D-printing. The material characteristics of the material(s) are then measured and applied to the design and model of the electromagnetic wave altering article. If the model reveals a discrepancy between the final design and the boundary conditions, rescaling is generally possible by adapting the material characteristics (e.g., by changing the permittivity in order to rescale the article).

Once the design model is completed the part can be produced using additive manufacturing and the application relevant characteristics (e.g., redirection of electromagnetic waves) characterized using an open field-testing set-up. If needed, adaptions to the design can be made to improve the performance of the electromagnetic wave altering article. Once the optimum design is achieved it can be applied by a user.

An electromagnetic radiation altering article according to the present disclosure may be useful for industrial applications, such as electronic applications, telecommunication applications, and transportation market applications (e.g., automotive and aerospace applications).

The polymer matrix is selected to be suitable for use in additive manufacturing. Typically, the polymer matrix is selected from the group consisting of thermoplastic polymers, thermoset polymers, elastomeric polymers, and any combinations or mixtures thereof. For instance, the polymer matrix may be selected from the group consisting of thermoplastic polymers, thermoset polymers, and any combinations or mixtures thereof. Exemplary suitable materials for use as the polymer matrix include, for instance and without limitation, poly(meth)acrylics, polyamides, nylons, acrylonitrile butadiene styrene (ABS), acrylonitrile styrene acrylates (ASA), polylactic acids (PLA), poly(lactic-co-glycolic acids), polycaprolactones (PCL), polycarbonates, polystyrenes, polyether ketone ketones (PEKK), polyether ether ketone (PEEK), polyphenyl sulfones (PPSF), polyanilines, polyvinyl ethers (PVE), epoxides, polyvinylidene fluorides (PVDF), polymethyl methacrylate (PMMA), polyacrylonitriles, polyvinyl chlorides, polyurethanes, polyesters, polyolefins, polyphenylene oxides, thermoplastic polyurethanes (TPU), perfluoroalkoxy alkanes (PFA), and any combinations or mixtures thereof.

In some embodiments, the polymer matrix is selected from the group consisting of polyamides; polymeric materials based on (meth)acrylate, vinyl ether, and epoxide containing monomers; thermoplastic polyurethanes (TPU); perfluoroalkoxy alkanes (PFA), and any combinations or mixtures thereof. In select embodiments, the polymer matrix is selected from the group consisting of polyamides (e.g., nylon 6, nylon 6,6, nylon 12, polypeptide, hexamethylene adipamide, and polycaprolactam); and polymeric materials based on (meth)acrylate containing monomers.

Suitable monofunctional (meth)acrylate monomers include for instance and without limitation, dicyclopentadienyl acrylate, dicyclopentanyl acrylate, dimethyl-1-adamantyl acrylate, cyclohexyl methacrylate, tetrahydrofurfuryl methacrylate, 2-phenoxyethyl methacrylate, butyl methacrylate (e.g., tert-butyl methacrylate or isobutyl methacrylate), benzyl methacrylate, n-propylmethacrylate, 3,3,5-trimethylcyclohexyl methacrylate, butyl-cyclohexylmethacrylate (e.g., cis-4-tert-butyl-cyclohexylmethacrylate, 73/27 trans/cis-4-tert-butylcyclohexylmethacrylate, or trans-4-tert-butylcyclohexyl methacrylate), 2-decahydronapthyl methacrylate, 1-adamantyl acrylate, dicyclopentadienyl methacrylate, dicyclopentanyl methacrylate, isobornyl methacrylate (e.g., d,l-isobornyl methacrylate), dimethyl-1-adamantyl methacrylate, bornyl methacrylate (e.g., d,l-bornyl methacrylate), 3-tetracyclo[4.4.0.1.1]dodecyl methacrylate, 1-adamantyl methacrylate, isobornyl acrylate, tertiary butyl acrylate, or combinations thereof.

Exemplary monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Exemplary monomers with three or four (meth)acryloyl groups include, but are not limited to, trimethylolpropane triacrylate (e.g., commercially available under the trade designation TMPTA-N from Cytec Industries, Inc. (Smyrna, GA, USA) and under the trade designation SR-351 from Sartomer (Exton, PA, USA)), pentaerythritol triacrylate (e.g., commercially available under the trade designation SR-444 from Sartomer), ethoxylated (3) trimethylolpropane triacrylate (e.g., commercially available under the trade designation SR-454 from Sartomer), ethoxylated (4) pentaerythritol tetraacrylate (e.g., commercially available under the trade designation SR-494 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), and di-trimethylolpropane tetraacrylate (e.g., commercially available under the trade designation SR-355 from Sartomer).

Exemplary monomers with five or six (meth)acryloyl groups include, but are not limited to, dipentaerythritol pentaacrylate (e.g., commercially available under the trade designation SR-399 from Sartomer) and a hexa-functional urethane acrylate (e.g., commercially available under the trade designation CN975 from Sartomer).

Typically, when dielectric particles are included, the plurality of dielectric particles is randomly distributed and embedded in the polymer matrix. In some embodiments, the dielectric particles comprise an inorganic material selected from the group consisting of oxides, nitrides, carbides, borides, titanates, zirconates, silicates, and any combinations or mixtures thereof. Exemplary suitable dielectric particles are optionally selected from the group consisting of (e.g., hollow) glass microspheres, coated (e.g., hollow) glass microspheres (e.g., in particular metal coated hollow glass microspheres), silicon carbides, zirconium oxides, aluminum oxides, (e.g., hexagonal) boron nitride particles, barium titanates, carbon nanotubes, graphite, graphene, polytetrafluoroethylene (PTFE) particles, carbonyl iron particles, sodium bismuth titanates, lead zirconate titanates, calcium zirconates, and any combinations or mixtures thereof. In certain embodiments, the dielectric particles are selected from the group consisting of (e.g., hollow) glass microspheres, metal coated (e.g., hollow) glass microspheres (e.g., in particular aluminum coated glass microspheres), silicon carbides, and any combinations or mixtures thereof. In select embodiments, the dielectric particles are metal coated hollow glass microspheres.

In certain embodiments, the (e.g., optional) dielectric particles comprise microparticles or nanoparticles. At least one dimension of a nanoparticle is smaller than 1 micrometer, such as 950 nanometers or less, 900, 850, 800, 750, 700, 650, 600, 550, 500, 450, 400, 350, or 300 nanometers or less; and 1 nanometer or larger, 2, 5, 7, 10, 12, 15, 18, 20, 25, 30, 35, 40, 45, 50, 55, 60, 65, 70, 75, 80, 85, 90, 95, 100, 125, 150, 175, 200, 225, 250, or 275 nanometers or larger. In certain embodiments, the (e.g., optional) dielectric particles have an average particle size (i.e., largest dimension) of 0.5 micrometers or greater, 1 micrometer or greater, 2 micrometers or greater, 3 micrometers or greater, 4 micrometers or greater, 5 micrometers or greater, 6 micrometers or greater, 7 micrometers or greater, 8 micrometers or greater, 9 micrometers or greater, 10 micrometers or greater, 12 micrometers or greater, 15 micrometers or greater, 18 micrometers or greater, 20 micrometers or greater, or 25 micrometers or greater; and an average particle size of 100 micrometers or less, 90 micrometers or less, 80 micrometers or less, 70 micrometers or less, 60 micrometers or less, 50 micrometers or less, 40 micrometers or less, 30 micrometers or less, or micrometers or less. Stated another way, an average particle size may range from 0.5 micrometers to 100 micrometers or 0.5 micrometers to 50 micrometers.

Typically, electromagnetic radiation altering articles (and photocurable compositions for making the articles) according to the present disclosure comprise 0.1 volume percent (vol. %) or greater of the (e.g., optional) dielectric particles, based on the total volume of the electromagnetic radiation altering article (or photocurable composition), 0.2 vol. % or greater, 0.5 vol. % or greater, 0.8 vol. % or greater, 1.0 vol. % or greater, 1.5 vol. % or greater, 2.0 vol. % or greater, 3.0 vol. % or greater, 4.0 vol. % or greater, 5.0 vol. % or greater, 6.0 vol. % or greater, 8.0 vol. % or greater, 10.0 vol. % or greater, 12.5 vol. % or greater, 15.0 vol. % or greater, 17.5 vol. % or greater, 20.0 vol. % or greater, 22.5 vol. % or greater, 25.0 vol. % or greater, 27.5 vol. % or greater, or 30.0 vol. % or greater; and 70.0 vol. % or less of the (e.g., optional) dielectric particles, based on the total volume of the electromagnetic radiation altering article (or photocurable composition), 65.0 vol. % or less, 62.5 vol. % or less, 60.0 vol. % or less, 57.5 vol. % or less, 55.0 vol. % or less, 52.5 vol. % or less, 50.0 vol. % or less, 47.5 vol. % or less, 45.0 vol. % or less, 42.5 vol. % or less, 40.0 vol. % or less, 37.5 vol. % or less, 35.0 vol. % or less, or 32.5 vol. % or less, of the (e.g., optional) dielectric particles, based on the total volume of the electromagnetic radiation altering article. Stated another way, electromagnetic radiation altering articles (or photocurable compositions) may comprise 0.1 vol. % to 70 vol. %, 1.0 vol. % to 50.0 vol. %, or 2.0 vol. % to 25.0 vol. % of the (e.g., optional) dielectric particles, based on the total volume of the electromagnetic radiation altering article.

In certain embodiments, the (e.g., optional) dielectric particles are present in an amount of 20 wt. % or greater, based on the total weight of the electromagnetic radiation altering article (or photocurable compositions), 22 wt. %, 25 wt. %, 28 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. %, 41 wt. %, 42 wt. %, 43 wt. %, or 44 wt. % or greater; and 60 wt. % or less, based on the total weight of the electromagnetic radiation altering article, 59 wt. %, 58 wt. %, 57 wt. %, 56 wt. %, 55 wt. %, 54 wt. %, 53 wt. %, 52 wt. %, 51 wt. %, 50 wt. %, 49 wt. %, 48 wt. %, 47 wt. %, or 46 wt. % or less. Stated another way, electromagnetic radiation altering articles (or photocurable compositions) may comprise 20 wt. % to 60 wt. %, 25 wt. % to 60 wt. %, 30 wt. % to 60 wt. %, 35 wt. % to 60 wt. %, 40 wt. % to 60 wt. %, or 30 wt. % to 45 wt. % of the (e.g., optional) dielectric particles, based on the total weight of the electromagnetic radiation altering article.

### Articles and Apparatuses

In a second aspect, the present disclosure provides a (e.g., three-dimensional) electromagnetic radiation altering article (e.g., part) obtained by a method according to the first aspect above. In particular, any detail(s) of the methods described above may be employed to prepare the electromagnetic radiation altering article of this second aspect.

In a third aspect, the present disclosure provides an apparatus comprising a (e.g., three-dimensional) electromagnetic radiation altering article according to the second aspect. Typically, the apparatus further comprises a device selected from the group consisting of electromagnetic radiation producing devices (e.g., an interferer or transmitter) and/or electronic devices (e.g., a victim). In some embodiments, the electronic device or the electromagnetic radiation producing device is selected from the group consisting of an antenna, an internet connected device, a smartphone, a tablet PC, a TV, a communication satellite, a wireless transmitter, a wireless router, a wireless amplifier, an autonomous driving assisting device, and any combinations thereof. Typically, the electromagnetic radiation altering article is integrated into the apparatus or device or placed in the vicinity of the apparatus or device. The placement of the electromagnetic radiation altering article can be selected to be between a device that emits electromagnetic radiation and a device or material that desired to be protected from effects of the emitted electromagnetic radiation. The electromagnetic radiation altering article can thus reflect, attenuate, redirect, or any combination thereof, the emitted electromagnetic radiation to decrease the amount of electromagnetic radiation that reaches (e.g., is received by) the device or material to be protected (e.g., the victim) from the emitting device.

### Methods of Altering Electromagnetic Radiation

In a fourth aspect, the present disclosure provides a method of altering electromagnetic radiation originating from an electromagnetic radiation producing device and received by an electronic device, wherein the method comprises the step of integrating an electromagnetic radiation altering article according to the second aspect above into the electronic device or placing an article according to the second aspect above in the vicinity of the electronic device. In some such methods, the electromagnetic radiation altering article according to any of the embodiments described above is associated with or near an electronic device to decrease electromagnetic radiation directed at the electronic device coming from the electromagnetic radiation producing devices, in which case the electronic device is a “victim”. In some such methods, the electromagnetic radiation altering article according to any of the embodiments described above is associated with or near an electronic device to redirect electromagnetic radiation to the electronic device emitted from the electromagnetic radiation producing devices, in which case the electronic device is a “receiver” (as opposed to a “victim”). One example of such a method would be to enable reception of a signal (e.g., 5G signals) in urban surroundings by reflecting the electromagnetic radiation in certain directions towards the electronic device.

In a fifth aspect, the present disclosure provides a method of altering electromagnetic radiation originating from an electromagnetic radiation producing device, wherein the method comprises the step of integrating an article according to the second aspect above into the electromagnetic radiation producing device or placing an article according to the second aspect above in the vicinity of the electromagnetic radiation producing device. In some such methods, the electromagnetic radiation altering article according to any of the embodiments described above is associated with or near the electromagnetic radiation producing device to decrease the electromagnetic radiation emitted from the device that could potentially interfere with other electronic devices, in which case the electronic device is a “victim”. In some such methods, the electromagnetic radiation altering article according to any of the embodiments described above is associated with or near an electromagnetic radiation producing device to redirect electromagnetic radiation to the electronic device emitted from the electromagnetic radiation producing devices, in which case the electronic device is a “receiver” (as opposed to a “victim”).

In the two above methods, the altering often comprises interfering with the electromagnetic radiation, such as by reflecting, attenuating, and/or redirecting electromagnetic radiation. In many embodiments, the electronic device or the electromagnetic radiation producing device is selected from the group consisting of an antenna, an internet connected device, a smartphone, a tablet PC, a TV, a communication satellite, a wireless transmitter, a wireless router, a wireless amplifier, an autonomous driving assisting device, and any combinations thereof.

The following Examples are set forth to describe additional features and embodiments of the invention.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims. Unless otherwise noted or readily apparent from the context, all parts, percentages, ratios, etc. in the Examples and the rest of the specification are by volume.

### Materials Used in the Examples

| Abbreviation | Description and Source |
|---|---|
| UCST 45 | Ultracure ST45 3D printing resin, obtained from BASF, Ludwigshafen, |
| | Germany |
| isopropanol | Isopropanol, obtained from Merck, Darmstadt, Germany |
| iM16K | iM16K glass bubbles, obtained from 3M, St. Paul, MN |
| barium titanate | Barium titanate(IV) powder <3 micrometer , obtained from Merck, |
| | Darmstadt, Germany |
| Silicon carbide | Silicon carbide sintered agglomerate, obtained from 3M, Kempten, |
| | Germany |
| Polyamide 12 | PA 2200 - Polyamide 12, obtained from EOS, Krailing, Germany |
| SR540 | Ethoxylated (4) bisphenol a methacrylate SR540, obtained from |
| | Sartomer, Colombes, France |
| TRGDMA | Triethyleneglycol dimethacrylate, obtained from Merck, Darmstadt, |
| | Germany |
| MA1 | Mixture of 2-hydroxyethyl methacrylate, 2,6-di-tert-butyl-p-cresol, 4- |
| | methoxyphenol, and polyurethane methacrylate (DESMA), obtained from |
| | 3M, St. Paul, MN |
| MA2 | Mixture of tetrahydrofuran and oxirane copolymer, bis(2-methyl-2- |
| | propenoate), and methacrylic acid, obtained from 3M, St. Paul, MN |
| HPMA | Mixture of hydroxypropyl and hydroxyisopropyl methacrylates, obtained |
| | from Merck, Darmstadt, Germany |
| OMNIRAD 819 | Bis(2,4,6-Trimethylbenzoyl)phenylphosphine oxide, having the trade |
| | designation OMNIRAD 819, obtained from IGM Resins, Waalwijk, |
| | Netherlands |

### Test Methods

### Dielectric Resonance (SPDR) Measurement Method

Dielectric constant and loss tangents of the material sample were measured using Split Post Dielectric Resonators (SPDR) in combination with a network analyzer. The nominal frequencies of the used SPDR are 10 gigahertz and 15 gigahertz. Other standard frequencies are 1.1 gigahertz, 2.4 gigahertz and 5 gigahertz.

Measurement Procedure:
Calibration of network analyzer
Coupling adjustment of the SPDR with the network analyzer.
Measurement of the empty SPDR (resonant frequency, Q-factor)
Measurement of the SPDR with material sample (resonant frequency, Q-factor)
Measurement of the sample thickness
Calculation of the complex dielectric parameters with SPDR specific software

The Accuracy for a Sample with the Thickness of h is:

Δε/ε=±(0.0015+Δh/h)

Δ tan δ=±2*10-5 or ±0.03*tans, whichever is higher

The material sample size for both SPDR should be 50 millimeters×40 millimeters x<0.5 millimeters.

For Measurements of the Dielectric Properties Below (and Including) 1 Gigahertz, the Following Procedure was Used:

Dielectric constant and loss tangents were measured using an impedance analyzer covering the frequency range of 1 megahertz to 1 gigahertz. To measure material properties, the analyzer was extended with a measurement fixture. The fixture for measurement of dielectric properties is converting the material parameters to a measurable impedance by using the principle of a parallel plate capacitor. The used measurement fixture can measure the frequency dependent dielectric constant (Dk) and the loss tangent (real and imaginary part of the impedance) in a frequency range from 1 megahertz to 1 gigahertz.

For most accurate results, the material under test (MUT) was prepared in discs with a thickness of 0.3 millimeters to 3 millimeters and a diameter ≥15 millimeters.

Calibration was performed with the vendor supplied calibration artefacts at the spot of the material measurement.

The exact thickness of each sample disc was measured using a caliper. With known values for impedance and thickness, a calculation can be performed to get the complex value for permittivity.

### Example 1: Preparation, Processing, and Measurement of a UV Curable 3D Printing Material with a High Dielectric Permittivity

Two batches, each consisting of 100.0 grams UCST 45 and 150.0 grams barium titanate, were mixed in a DAC 400 FVZ/VAC-P/LR Speedmixer (Hauschild GmbH, Hamm, Germany) for 4 minutes at 2500 rounds per minute at 400 millibar, and combined afterwards. This mixture was filled into the reservoir of a D3011 3D printer (Rapid Shape GmbH, Heimsheim, Germany) directly after mixing and the print job was started.

Print job preparation was done with a Netfabb 2019 (Autodesk, San Rafael, CA) with the following parameters: energy dose: 950 millijoule per square decimeter; support width: 200 micrometer; Offset: 0 micrometer; shrinkage: 0.6 percent; Z-compensation: 0 micrometers; layer size: 25 micrometers; burn in factor: 500 percent.

3D printed parts were carefully removed from the platform after printing and transferred into a closable container containing isopropanol. This container was transferred into a Sonorex Super RK 1028 BH ultrasonic bath (Bandelin electronic GmbH, Berlin, Germany) filled with water and exposed to ultrasonication for 15 minutes. Afterwards, the parts were removed from the container and residual 3D printing material and isopropanol were removed using compressed air. This cleaning procedure was performed two times.

After cleaning each part, the parts were post cured in a RS Cure UV curing chamber (Rapid Shape GmbH, Heimsheim, Germany) using both wavelengths at maximum intensity under vacuum for 1200 seconds.

Measurement of the dielectric properties was done according to the Dielectric Resonance (SPDR) Measurement Method at 10 gigahertz and 15 gigahertz. The results are shown in Table 1 below.

TABLE 1
Dielectric properties of Example 1

| | 10 gigahertz | 15 gigahertz |
|---|---|---|
| Dielectric permittivity εᵣ | 7.5 | 7.2 |
| Dielectric loss tangent | 0.053 | 0.054 |

### Example 2: Preparation Processing and Measurement of a UV Curable 3D Printing Material with a Low Dielectric Permittivity

Two batches of 75.4 grams SR 540, 75.4 grams TRGDMA, 26.2 grams MA 1, 16.6 grams HPMA, 4.8 grams MA 2, 1.4 grams OMNIRAD 819 and 68 grams iM16 K glass bubbles were mixed in a DAC 400 FVZ/VAC-P/LR Speedmixer (Hauschild GmbH, Hamm, Germany) for 2 minutes at 1400 rounds per minute at 400 millibar. This mixture was filled into a D3011 3D printer (Rapid Shape GmbH, Heimsheim, Germany) directly after mixing and the print job was started.

Print job preparation was done with Netfabb 2019 (Autodesk, San Rafael, CA) with the following parameters: energy dose: 500 millijoules per square decimeter; support width: 200 micrometers; Offset: 0 micrometers; shrinkage: 0.6 percent; Z-compensation: 0 micrometers; layer size: 50 micrometers; burn in factor: 500 percent.

3D printed parts were carefully removed from the platform after printing and transferred into a closable container containing isopropanol. This container was transferred into a Sonorex Super RK 1028 BH ultrasonic bath (Bandelin electronic GmbH, Berlin, Germany) filled with water and exposed to ultrasonication for 15 minutes. Afterwards, the parts were removed from the container and residual 3D printing material and isopropanol were removed using compressed air. This cleaning procedure was done two times.

After cleaning each part, the parts were post cured in a RS Cure UV curing chamber (Rapid Shape GmbH, Heimsheim, Germany) using both wavelengths at maximum intensity under vacuum for 1200 seconds.

Measurement of the dielectric properties was done according to the Dielectric Resonance (SPDR) Measurement Method at 2.4 gigahertz and 5.2 gigahertz. The results are shown in Table 2 below.

TABLE 2
Dielectric properties of Example 2

| | 2.4 gigahertz | 5.2 gigahertz |
|---|---|---|
| Dielectric permittivity εᵣ | 2.1 | 2.2 |
| Dielectric loss tangent | 0.02 | 0.02 |

### Example 3: Preparation, Processing and Measurement of a Thermoplastic 3D Printing Powder Material with a High Dielectric Loss Factor

2.15 kilograms polyamide 12 powder and 2.85 kilograms silicon carbide powder were weighed into a round container and first mixed shaking the closed container. Afterwards, the powders were further mixed by using roller trestle at 30 rounds per minute for 10 minutes. The powder container was connected to a Formiga P110 selective laser sintering 3D printer (EOS GmbH, Krailing, Germany). The printer was prepared by creating a powder bed and pre-heating the machine for 2 hours at a temperature of 150° C. under nitrogen atmosphere. For the print job the temperatures for the main chamber were set to 150° C. and for the infrared heater to 175° C. The laser process was performed using the standard parameter set for PA12 provided by EOS.

The print job was prepared using Magics (Materialise, Lowen, Belgium).

After the printing process the printer was allowed to cool down for 12 hours before the parts were removed from the printer and cleaned by sand blasting with glass media.

Measurement of the dielectric properties was done according to the Dielectric Resonance (SPDR) Measurement Method at 1 GHz. The results are shown in Table 3 below.

TABLE 3
Dielectric properties of Example 3

| | 1 Gigahertz |
|---|---|
| Dielectric permittivity εᵣ | 6.3 |
| Dielectric loss tangent | 0.149 |

### Example 4: Using a Honeycomb Design to Reduce the Dielectric Properties of a 3D Printed Body

Two CAD files of plates were generated using Netfabb 2019 (Autodesk, San Rafael, CA) and Magics (Materialise, Lowen, Belgium). Both plates had a thickness of 1.85 millimeters. One plate was made as a solid body with a density of 1.15 grams per cubic centimeters. The second plate was printed using a honeycomb design resulting in a 33% density reduction. Referring to FIG. 8, a reduced density plate 800 is shown, having a first solid outer wall 810 connected to a second outer wall 820 by an interior material having a corrugated shape 830. The plate 800 thus defines a plurality of open spaces 840, which reduce the density of the overall plate 800.

A 3D printing resin consisting of 75.4 grams SR 540, 75.4 grams TRGDMA, 26.2 grams MA 1, 16.6 grams HPMA, 4.8 grams MA 2 and 1.4 grams OMNIRAD 819 was used to print the plates. This mixture was filled into the reservoir of a D3011 3D printer (Rapid Shape GmbH, Heimsheim, Germany) the print job was started.

Print job preparation was done with Netfabb 2019 (Autodesk, San Rafael, CA) with the following parameters: energy dose: 400 millijoule per square decimeter; support width: 200 micrometers; Offset: 0 micrometers; shrinkage: 0.6 percent; Z-compensation: 0 micrometers; layer size: 50 micrometers; burn in factor: 500 percent.

3D printed parts were carefully removed from the platform after printing and transferred into a closable container containing isopropanol. This container was transferred into a Sonorex Super RK 1028 BH ultrasonic bath (Bandelin electronic GmbH, Berlin, Germany) filled with water and exposed to ultrasonication for 15 minutes. Afterwards, parts were removed from the container and residual 3D printing material and isopropanol were removed using compressed air. This cleaning procedure was done two times.

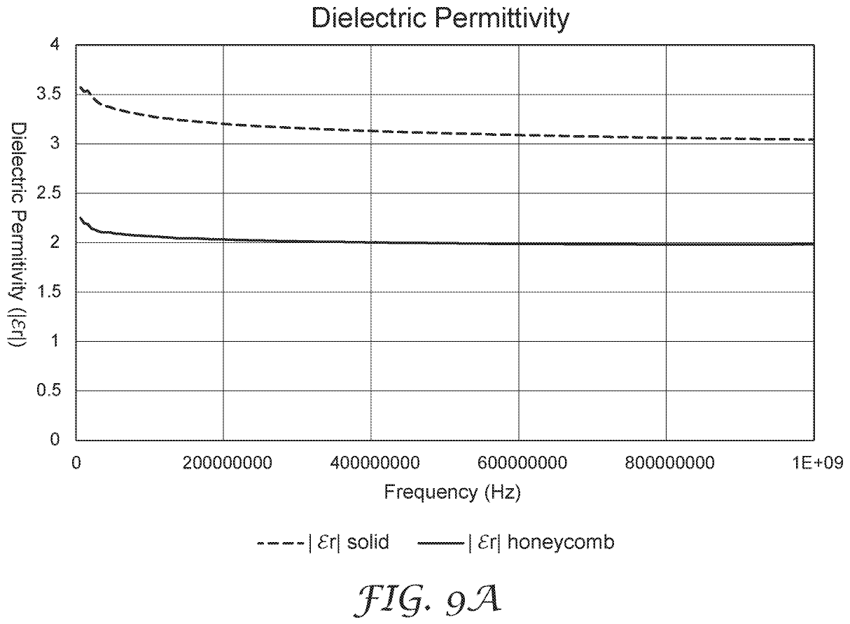

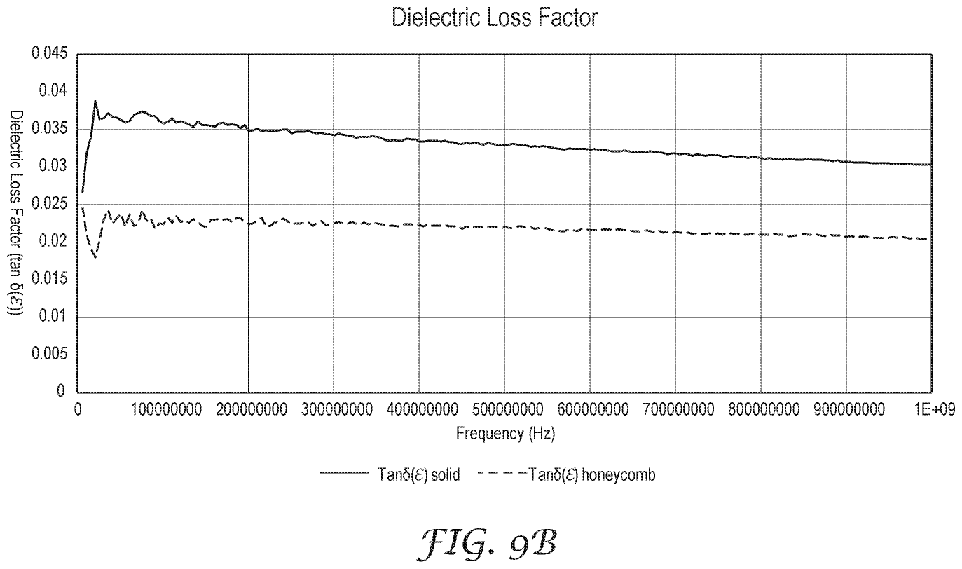

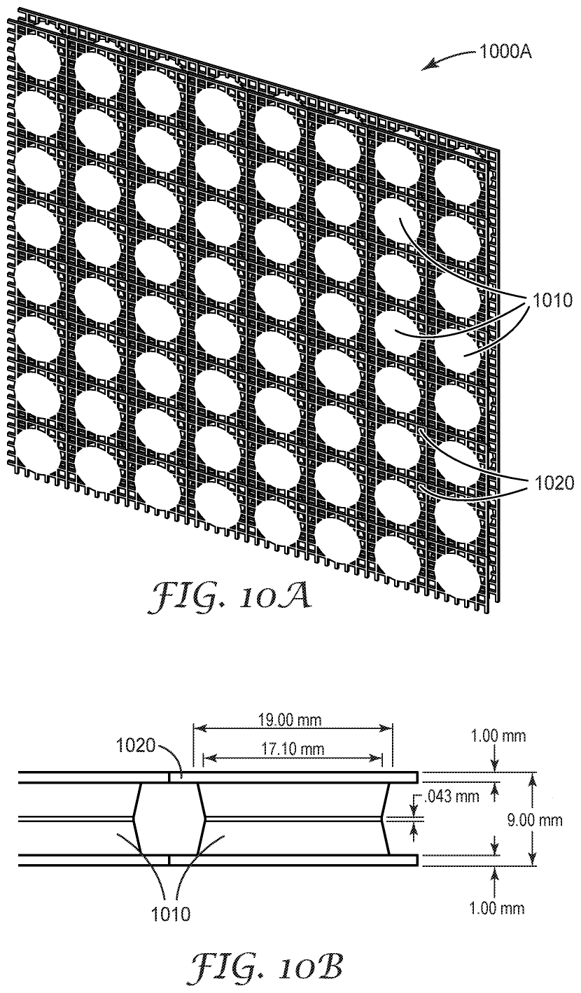

Measurement of the dielectric properties of the solid plate and the honeycomb plate was done according to the Dielectric Resonance (SPDR) Measurement Method. The difference in dielectric permittivity between the two plates is plotted as a function of frequency in the graph of FIG. 9A. The difference in dielectric loss factor between the two plates is plotted as a function of frequency in the graph of FIG. 9B.

### Example 5: Design and Verification of Pure Dielectric Frequency Selective Surface Using Cylindric Dielectric Resonators

To form a pure dielectric frequency selective surface (FSS), multiple cylindric disc dielectric resonators were designed to be arranged in a matrix having a constant pitch. The material from which the sample was made was polyamide 12 (PA12), a dielectric material often used with 3D printers.

Electromagnetic properties of the PA12 material were measured according to the Dielectric Resonance (SPDR) Measurement Method. PA12 was determined to have a dielectric constant (e.g., real part of permittivity) of about 2.44 and a loss tangent of 0.007 at 10 GHz.

To keep the resonators in place and to increase mechanical stability, a grid structure is applied as layers on the outer shell of the resonator array. The grid was designed such that the features (e.g., grid-size) are small compared to the target wavelength so the whole grid will have minor effect on the resonances and can be treated as sheets of plain material with a reduced permittivity. The design was performed using the 3D electromagnetic simulation software CST/Dassault Design Suite.

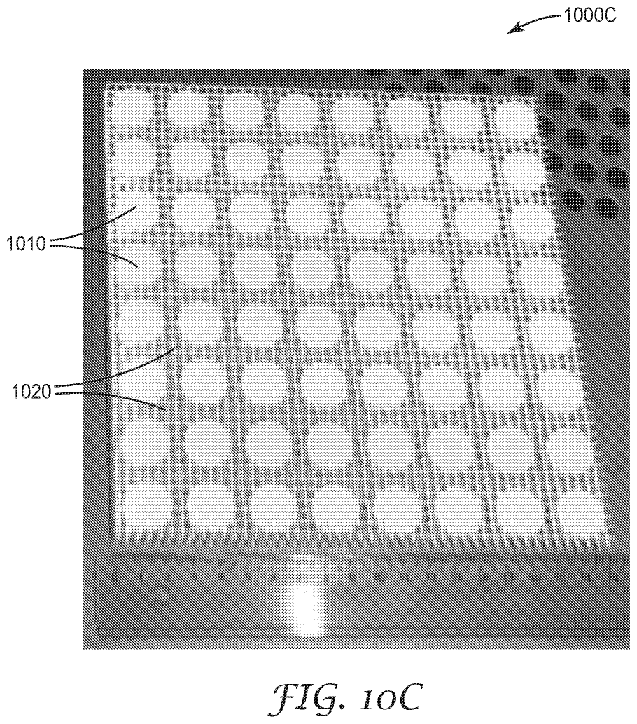

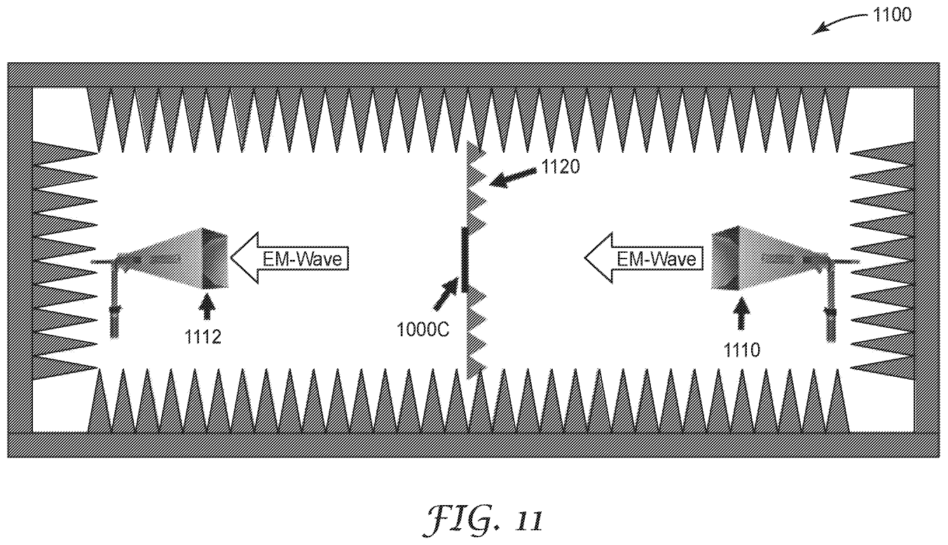

The model of the prototype of the array is shown in FIG. 10A. The prototype 1000A included cylindric disc dielectric resonators 1010 having a varying diameter along the z-axis. With that resonator style, the total volume of the resonator can be further tuned very precisely without having to modify the outer diameter, so in this case without having to change the outer grid structure 1020. Further dimensions can be obtained from FIG. 10B. One “cell” is defined as an 24 millimeter (mm) by 24 mm square cutout of the X/Y Plane, whose edges are aligned tangentially to the edges of the grid 1020 and the center of the square equals the center of the cylinder 1010.

From the 3D Simulation, a 3D CAD File was generated wand used to additive-manufacture (3D print) the prototype sample, shown in FIG. 10C. The structure 1000C was analyzed using the procedure described above.

Referring to FIG. 11, to test the FSS array structure 1000C, an anechoic and shielded chamber 1100 was used containing a specialized test setup created for this measurement to conduct measurements including two well-known test-antennas, a transmitter antenna 1110 and a receiver antenna 1112 on each side of the chamber 1100 interior, positioned face-to-face. The chamber 1100 was designed to ensure that the setup was shielded from surrounding influences and to minimize unwanted reflections inside the chamber 1100. The distance between each test-antenna 1110, 1112 and the FSS sample 1000C was between 2 m and 2.5 m and equal for both antennas. It is preferred to choose the distance to be big enough to exceed the Fraunhofer distance. In the middle of the chamber 1100, at the same distance from each test antenna 1110, 1112, a barrier plane 1120 was placed, made of pyramidic foam absorbers facing towards the transmitting-antenna side. In the middle of the plane 1120 (e.g., at a height of about 1.5 m), a small window was cut out of the absorbers with the size of the FSS sample 1000C. This window is called the transmissive area and the FSS sample 1000C was placed in that window. The test antennas 1110, 1112 were selected to cover the measurement bandwidth.

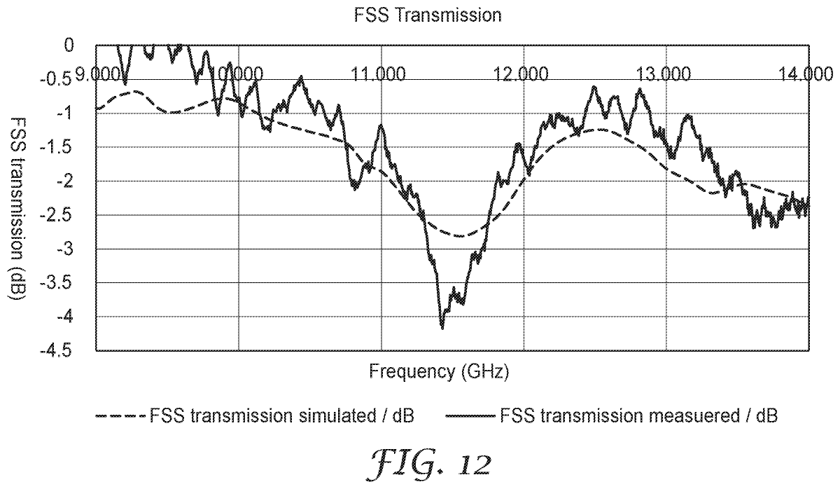

Calibration was performed by performing a transmission measurement with an empty transmissive area, called a “thru” measurement. The sample 1000C was then placed in the window area of the chamber 1100 and the measurement was repeated. The results were normalized to the “thru” measurement. Referring to FIG. 12, four major frequency areas were identified. One passband ranges up to around 11.4 GHz. A passband is a frequency band where RF waves can pass through the structure without getting substantially attenuated (attenuation <2 dB). A stopband ranges from about 11.4 GHz until 11.6 GHz with a center of 11.5 GHz. A stopband is defined as a frequency band where RF waves are attenuated or reflected and cannot substantially pass through the structure (attenuation ≥2 dB). The third area is another passband from about 11.6 GHz until about 12.5 GHz. The fourth region starts at about 12.5 GHz and is formed by higher order modes of the resonator and the grid. This area is not intended to be used for an application. The FSS should be designed to shift the lower frequency of area four as high as possible (as far away as possible to the underlying passband). Up to 12.5 GHz the frequency behavior of the FSS can be generally described as band-stop filter. Comparison of measurement and simulation in FIG. 12 show good alignment with some minor differences that are mainly due to imperfect measurement setup, which was not captured by simulation.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A method for manufacturing an electromagnetic radiation altering article, which comprises the steps of:
a) forming an electromagnetic radiation altering material by providing a polymer matrix and optionally embedding a plurality of dielectric particles in the polymer matrix;
b) obtaining initial dielectric properties of the electromagnetic radiation altering material, comprising the initial relative dielectric permittivity (εr 1) and the initial dielectric loss tangent (tan delta 1) when measured at a frequency F1;
c) modeling electromagnetic radiation altering features of the electromagnetic radiation altering material suitable for the electromagnetic radiation altering article obtained from the electromagnetic radiation altering material to have target electromagnetic radiation altering properties, thereby obtaining a simulation of the electromagnetic radiation altering article;
d) additive manufacturing the electromagnetic radiation altering article based on the simulation of the electromagnetic radiation altering article; and
e) optionally, measuring the electromagnetic radiation altering properties of the electromagnetic radiation altering article obtained from additive manufacturing, and comparing the measured electromagnetic radiation altering properties of the electromagnetic radiation altering article with the target electromagnetic radiation altering properties.

2. The method of claim 1, wherein the plurality of dielectric particles is present and is randomly distributed and embedded in the polymer matrix.

3. The method of claim 1, wherein the method further comprises the step of obtaining initial magnetic properties of the electromagnetic radiation altering material, comprising the initial relative magnetic permeability (μr 1), the initial magnetic loss tangent (tan delta 3), or both, when measured at a frequency F1.

4. The method of claim 1, wherein the step of modeling electromagnetic radiation altering features of the electromagnetic radiation altering material comprises the step of optimizing the electromagnetic radiation altering features of the electromagnetic radiation altering material for it to have target electromagnetic radiation altering properties, simulating the electromagnetic radiation altering properties of the simulation of the electromagnetic radiation altering article by conducting electromagnetic radiation altering calculations on the simulation of the electromagnetic radiation altering article, or both.

5. The method of claim 4, wherein the step of forming an electromagnetic radiation altering material comprises the steps of selecting an initial polymer matrix and selecting a plurality of initial dielectric particles for embedding therein, and further comprising the step of replacing the initial polymer matrix and/or the plurality of initial dielectric particles by a different polymer matrix and/or a different plurality of dielectric particles, and reiterating the process after the step of modeling electromagnetic radiation altering features of the electromagnetic radiation altering material.

6. The method of claim 1, further comprising the step of re-modeling electromagnetic radiation altering features of the electromagnetic radiation altering material and reiterating the process after the step of measuring the electromagnetic radiation altering properties of the electromagnetic radiation altering article obtained from additive manufacturing.

7. The method of claim 1, wherein the target electromagnetic radiation altering properties comprise dielectric properties of the electromagnetic radiation altering article comprising a target relative dielectric permittivity (εr 2) and a target dielectric loss tangent (tan delta 2), magnetic properties of the electromagnetic radiation altering material comprising a target relative magnetic permeability (μr 2), magnetic properties of the electromagnetic radiation altering material comprising a target magnetic loss tangent (tan delta 4), or any combination thereof, when measured at a frequency F2.

8. The method of claim 1, wherein the polymer matrix is selected from the group consisting of polyamides, polymeric materials based on (meth)acrylate, vinyl ether, and epoxide containing monomers; thermoplastic polyurethanes (TPU); perfluoroalkoxy alkanes (PFA), and any combinations or mixtures thereof.

9. The method of claim 1, wherein the dielectric particles are present and are selected from the group consisting of glass microspheres, coated glass microspheres, silicon carbides particles, zircon oxides particles, aluminum oxides particles, boron nitride particles, barium titanates particles, carbon nanotubes, graphite, graphene, polytetrafluoroethylene (PTFE) particles, carbonyl iron particles, sodium bismuth titanates particles, lead zirconate titanates particles, calcium zirconates particles, and any combinations or mixtures thereof.

10. The method of claim 1, wherein the step of obtaining initial dielectric properties of the electromagnetic radiation altering material is performed using a measurement method selected from the group consisting of transmission method, reflection method, dielectric resonance (SPDR) method, capacitance method, LC resonance (U/I) method, perturbation method, open resonator method, and any combinations thereof.

11. The method of claim 1, wherein the electromagnetic radiation altering features of the electromagnetic radiation altering material are selected from the group consisting of electromagnetic lenses, diffractive gratings, frequency selective surfaces or materials, electromagnetic energy absorbers, metamaterials, and any combinations thereof.

12. The method of claim 1, wherein the step of additive manufacturing the electromagnetic radiation altering article based on the simulation of the electromagnetic radiation altering article is performed using an additive manufacturing method selected from the group consisting of stereolithography (SLA), selective laser sintering (SLS), digital light processing (DLP) material jetting, and any combinations thereof.

13. The method of claim 1, wherein the electromagnetic radiation altering material has an initial relative dielectric permittivity (εr 1) in the range from 1 to 3.0, from 1 to 2.8, from 1.0 to 2.5, from 1.2 to 2.3, from 1.5 to 2.0, from 4 to 11, from 4.5 to 11, from 5 to 10, from 5 to 9, from 5 to 8, or even from 12 to 15, when measured at 5.2 GHz according to the Dielectric Resonance (SPDR) Measurement Method.

14. The method of claim 1, wherein the electromagnetic radiation altering material has an initial dielectric loss tangent (tan delta 1) in the range from 0.01 to 0.04, from 0.01 to 0.03, from 0.01 to 0.02, from 0.05 to 0.15, from 0.06 to 0.12, from 0.08 to 0.12, from 0.2 to 0.5, from 0.2 to 0.45 or even from 0.2 to 0.4, when measured at 5.2 GHz according to the Dielectric Resonance (SPDR) Measurement Method.

15. The method of claim 1, wherein the electromagnetic radiation altering material has an initial relative magnetic permeability (μr 1) in the range from 1 to 1.5, from 1 to 1.3 or even from 1 to 1.2, when measured at 1.0 GHz according to the LC Resonance (U/I) Measurement Method.

16. The method of claim 1, wherein the frequency F1 or F2 is in a range from 300 MHz to 300 GHz, from 300 MHz to 3 GHz, 3 GHz to 30 GHz or even from 30 GHz to 300 GHz.

17. An electromagnetic radiation altering article obtained by the method of claim 1.

18. An apparatus comprising the electromagnetic radiation altering article of claim 17.

19. The apparatus of claim 18, further comprising a device selected from the group consisting of electromagnetic radiation producing devices, electronic devices, and any combinations thereof, wherein the electromagnetic radiation altering article is integrated into the device or placed in the vicinity of the device.

20. (canceled)

21. A method of altering electromagnetic radiation originating from an electromagnetic radiation producing device, wherein the method comprises the step of integrating an article of claim 17 into the electromagnetic radiation producing device or placing an article of claim 17 in the vicinity of the electromagnetic radiation producing device.
